(19) United States
(12) Patent Application Publication
(10) Pub. No.: US 2009/0226237 A1
(43) Pub. Date: Sep. 10, 2009

(54) Toothpaste Tube

(76) Inventors: Harald Kraus, Buckenhof (DE); Knud Klingler, Engerwitzdorf (AU)

Correspondence Address: KANESAKA BERNER AND PARTNERS LLP, 1700 DIAGONAL RD, SUITE 310, ALEXANDRIA, VA, 22314-2848, US

(21) Appl. No.: 12/225,593

(22) PCT Filed: Feb. 10, 2007
(86) PCT No.: PCT/EP2007/001143

§ 371 Date: May 12, 2009

(30) Foreign Application Priority Data
Apr. 5, 2006 (DE) 10 2006 016 726.0
Sep. 21, 2006 (DE) 10 2006 044 670.4

(51) Int. Cl. A46B 11/00; A61C 15/00; A46B 9/04

(52) U.S. Cl. 401/118; 132/321; 15/167.1

(57) ABSTRACT

The invention relates to a toothpaste tube having a holding means (10, 12, 16, 20, 23, 24, 25, 27, 32) which is attached to it for holding at least one interdental toothbrush (13).

Toothpaste tubes are generally known from the prior art. These days they are mostly made of plastic and have a flexible tube body for accommodating the toothpaste. The tube body is provided at an end with a mostly frustoconical tube base which has a tube opening on a tube nozzle extending out from the former. The tube nozzle is usually provided with an outer thread for screwing on a closure.

The closure can have a fastening element for screwing on to the tube nozzle and a lid fixed movably to the fastening element. The fastening element also has a breakthrough connected to the tube opening, which can be closed with the lid in the manner of a snap lock.

DE 196 33 573 A1 discloses a toothpaste tube, whereof the closure is combined with a dental floss dispenser. Integrating a dental floss dispenser into the closure of a toothpaste tube is time-consuming and expensive. This model was unable to breakthrough onto the market.

So-called interdental toothbrushes are also known from the prior art. These are small brushes provided with a gripping part for cleaning interdental spaces. Widespread periodontal disease can be effectively countered by regular cleaning of interdental spaces, in particular using toothpaste. Such interdental toothbrushes are currently being recommended especially by dentists. The advantages of using interdental toothbrushes in daily dental care are not yet sufficiently established in the mind of the user.

The object of the invention is to eliminate the disadvantages from the prior art and in particular to provide a simple and cost-effective possibility with which the use of interdental toothbrushes can be brought to the user.

This object is solved by the features of claim 1. Effective configurations of the invention will emerge from the features of claims 2 to 27.

According to the invention a toothpaste tube with attached holding means for holding at least one interdental toothbrush is provided. By the interdental toothbrush being held attached in holding means on the toothpaste tube according to the invention, the user is reminded during daily dental care of the advantages of using interdental toothbrushes. The user will use the interdental toothbrush held on the toothpaste tube for dental care. At the same time the toothpaste accommodated in the toothpaste tube can advantageously be applied immediately to the interdental toothbrush. Such use of interdental toothbrushes lowers the risk or advance of periodontal disease.

A further advantage of the suggested toothpaste tube is that the user does not have to look for two separate products in the supermarket, which are frequently confusingly sorted, but can get both products in a single procedure.

One or more interdental toothbrushes can be held in many different ways on a toothpaste tube. According to an advantageous configuration the holding means are a component of a closure of the toothpaste tube. Such a closure is usually an injection-moulded plastic part. Suitable holding means for accommodating an interdental toothbrush can be readily provided thereon by corresponding change to the injection mould.

The holding means are expediently a recess provided on the closure for accommodating the interdental toothbrush. The interdental toothbrush can be held by a grip element provided thereon or by a holder section extending therefrom advantageously frictionally engaged in the holder, preferably in the recess. The interdental toothbrush can easily be inserted into the recess for example with the grip element or the holder.

According to another configuration a first inner thread is provided on the closure for engaging in a first outer thread provided on a tube nozzle having a tube opening. In this way the closure can be connected quickly and easily to the tube body, here to a tube nozzle extending from a tube base. The closure expediently has a fastening element including the first inner thread, to which a lid is movably attached. The fastening element can also have a breakthrough connected to the tube opening. At the same time the first inner thread is provided expediently on a tube-side end of a tube section forming the breakthrough. The fastening element can be fastened to the tube nozzle using the first inner thread. A separate closure element is provided for closing the breakthrough provided on the fastening element. The fastening element therefore forms a type of adapter, designed correspondingly to the closure element.

According to a configuration a second inner thread is provided for engaging a corresponding second outer thread on an interdental toothbrush as holding means on a second end of the breakthrough opposite the first end, so that the breakthrough can be closed by screwing in the interdental toothbrush. With this configuration the interdental toothbrush itself therefore forms a closure element for closing the breakthrough. At the same time a brush element extending from a grip element of the interdental toothbrush can protrude into the tube nozzle. With this configuration the user has already the interdental toothbrush in hand when opening the toothpaste tube.

According to another particularly simple configuration the tube nozzle has a third inner thread corresponding to the second outer thread, so that the tube opening can be closed by screwing in the interdental toothbrush. In this case the interdental toothbrush itself therefore forms a closure for closing the tube opening.

According to an alternative configuration the recess for receiving the interdental toothbrush is provided on the fastening element. In this case the breakthrough is not closed necessarily by screwing in an interdental toothbrush. A projection for closing the lid corresponding to the breakthrough can be provided on the lid for this purpose. In its closed state the lid can expediently be latched with the fastening element, in the manner of a snap lock.

According to a particularly advantageous configuration the fastening element has a circular, preferably cylindrical, wall which is attached via a base to the tube section extending preferably radially to the tube section. With this configuration of the fastening element in particular the recess can be provided in the base so that an interdental toothbrush accommodated or respectively inserted therein projects into a space enclosed by the circular wall, the base and a tube base. This can simply and effectively counter soiling of the interdental toothbrush. The interdental toothbrush accommodated in such a fastening element is sheathed by the closure when the lid is closed. Providing the holding means in particular dispenses with any projections interrupting the contour of the closure or the like.

In its closed state the lid expediently covers over the interdental toothbrush held in the holding means. This can easily prevent the interdental toothbrush from unintentionally dropping out of the holding means.

According to a further variant of the invention the holding means are attached detachably on the closure, on the tube nozzle or on a tube body. For this purpose the holding means can comprise fastening means at least partially encompassing the closure, the tube nozzle or the tube body. In a simple configuration the holding means can consist of an injection-moulded, preferably flexible, disc, in which a central breakthrough is provided as fastening means. The holding means can thus be slipped onto a tube nozzle and then fixed in place by screwing of the closure onto the tube nozzle. For holding interdental toothbrushes at least one recess can be provided in the vicinity of a rim of such a plastic disc for preferably frictionally engaged accommodating of the interdental toothbrush.

According to a further configuration the fastening element can also be a flexible strip. The flexible strip can be elastic so that the holding means can thus be attached for example in a force-fitted manner to the tube body. Pipe sections or quiver-like elements for inserting interdental toothbrushes can be provided on the flexible strip for holding interdental toothbrushes.

According to a further configuration the holding means have another recess for preferably frictionally engaged accommodating of a toothpick. In similar fashion another recess for preferably frictionally engaged accommodating of a toothpick can also be provided in the grip element of the interdental toothbrush. Providing a toothpick first enables coarse cleaning of interdental spaces prior to using an interdental toothbrush. The proposed kit comprising toothpaste tube, interdental toothbrush and toothpick enables more comprehensive and thorough dental care. It is understood that other means for dental care can also be held in the recess or the other recess in place of the toothpick or as a complement to the toothpick.

Several interdental toothbrushes can be held on the holder. The interdental toothbrushes can have different shapes. The interdental toothbrush generally has a grip element, from which a brush extends. A holder section can be provided between the grip element and the brush. The holder section can be designed smooth and be suitable for frictionally engaged accommodating in the holding means. The third outer thread can also be attached to the holder section. A bead can be provided between the holder section and the grip element. The grip element can also be designed angled. The proposed angled design of the interdental toothbrush enables cleaning of interdental spaces in hard-to-reach places.

According to a further configuration the interdental toothbrush and/or the toothpick are connected via a predetermined breaking point to the closure or the holding means. The predetermined breaking point can be formed for example by a narrow bar or a narrow bridge which enables the interdental toothbrush to be removed when bent from side to side. In this case it is particularly and advantageously possible to produce the closure in the injection-moulding process in one injection with the interdental toothbrush and/or the toothpick. In this case the user only needs to loosen the interdental toothbrush and/or the toothpick from the closure by making a break at the predetermined breaking point. The interdental toothbrush and/or the toothpick loosened from the closure can then be inserted for keeping into the holding means. With the proposed configuration there is a cost saving by packing the closure associated with an interdental toothbrush and/or a toothpick. Affixing or respectively inserting the interdental toothbrush and/or the toothpick into the holding means is in this case done by the user.

According to a further particularly advantageous configuration the grip element has a connector extending radially with respect to a longitudinal axis of the brush, which preferably comprises a plate. Providing the plate extending radially from the grip with respect to the longitudinal axis of the brush element makes it easier to grip and handle the interdental toothbrush.

The plate expediently has a plate breakthrough. An extension element which can be connected to the grip element or the connector provided thereon can also be provided. At one end of the extension element a stud designed to correspond to the plate breakthrough and for making a snap-in connection with the plate can be provided. This enables the extension element to be connected firmly to the interdental toothbrush. This makes it easier to introduce the interdental toothbrush in particular into interdental spaces in the region of the molars. The proposed latch connection between the extension element and the interdental toothbrush can be released so that the extension element can be removed any time from a used interdental toothbrush and a new interdental toothbrush can be attached thereto.

According to a further advantageous configuration a bar is provided on the extension element in the vicinity of the stud such that a plate edge rests thereon when the plate is attached to the extension element. The proposed configuration guarantees antitwist connection of the interdental toothbrush or respectively of the plate extending therefrom with the extension element. This further facilitates handling of the interdental toothbrush extended by the extension element. Also, the interdental toothbrush can thus be latched in three different positions relative to the extension element. A first position is characterised in that the interdental toothbrush runs with its axis substantially parallel to the longitudinal extension of the extension element, thus prolonging the interdental toothbrush maximally. Both the other positions are characterized in that the interdental toothbrush extends from the extension element at an angle of 90°. This in particular makes cleaning of the interdental cavities in the region of the molars easier.

The connection between the interdental toothbrush, in particular the gripping part of same, and the extension element can of course also be configured differently. For example, a gripping part is conceivable which is provided with a gripping part recess for frictionally engaged insertion or latching of the extension element. The recess can be provided on an extension part extending substantially radially from the gripping part. More such recesses can also be provided so that the gripping part can be attached in various positions with respect to the extension piece. Another purpose of the abovementioned recess is to fasten the interdental toothbrush on the holding means or on the base. For this purpose further studs extending from the holding means or from the base can for example be provided, which are designed to correspond to the recesses so that the interdental toothbrushes can be stuck onto them. It is also conceivable to connect the extension element by means of a threaded or bayonet connection to a correspondingly designed configuration of the gripping part.

According to a further particularly advantageous configuration the base or the holding means has an extension element recess for preferably frictionally engaged accommodating of the extension element. The extension element can likewise advantageously be attached on the base or on the holding means, similarly as for the interdental toothbrush. The extension element recess is designed to correspond to a cross-section of the extension element. It is expediently substantially rectangular, round, half round or oval or can also be configured in other geometrical forms. With the above described configuration of the extension element the stud and/or bar formed thereon serves expediently as stop means and limits the insertion depth in the extension element recess. Of course, depending on the configuration of the extension element other means for limiting the insertion depth of the extension element can also be provided.

Embodiments of the invention will now be explained in greater detail hereinbelow by means of the drawings, in which:

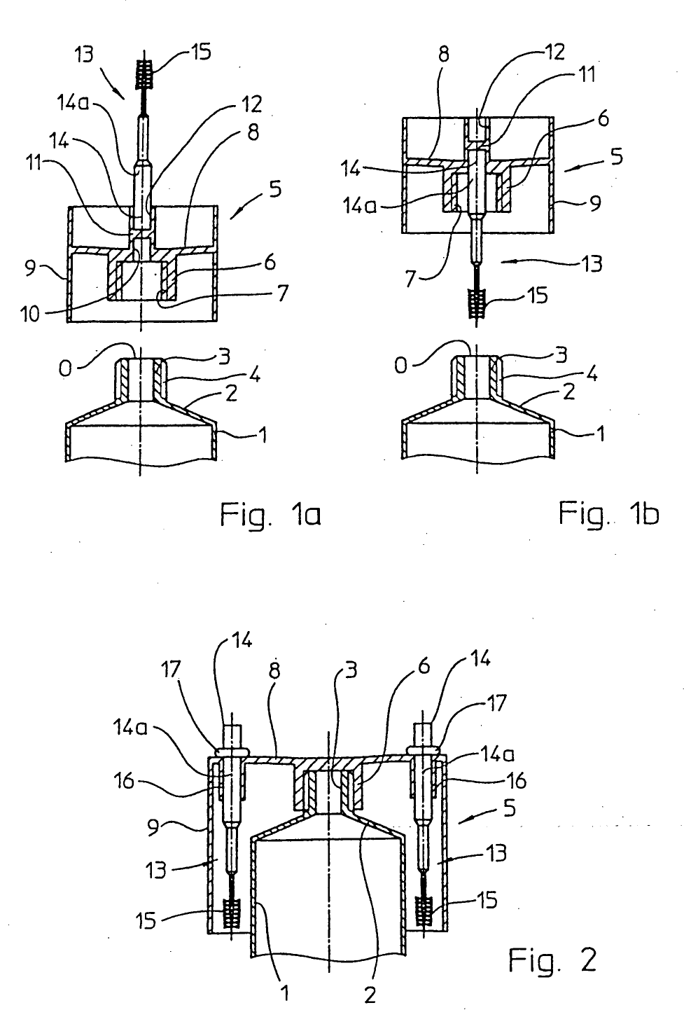

FIG. 1a is a schematic sectional view through a first closure, on which an interdental toothbrush is held in a first position outside the tube,

FIG. 1b is a schematic sectional view according to FIG. 1a, wherein the interdental toothbrush is held in a second position projecting into the tube,

FIG. 2 is a schematic sectional view through a second closure,

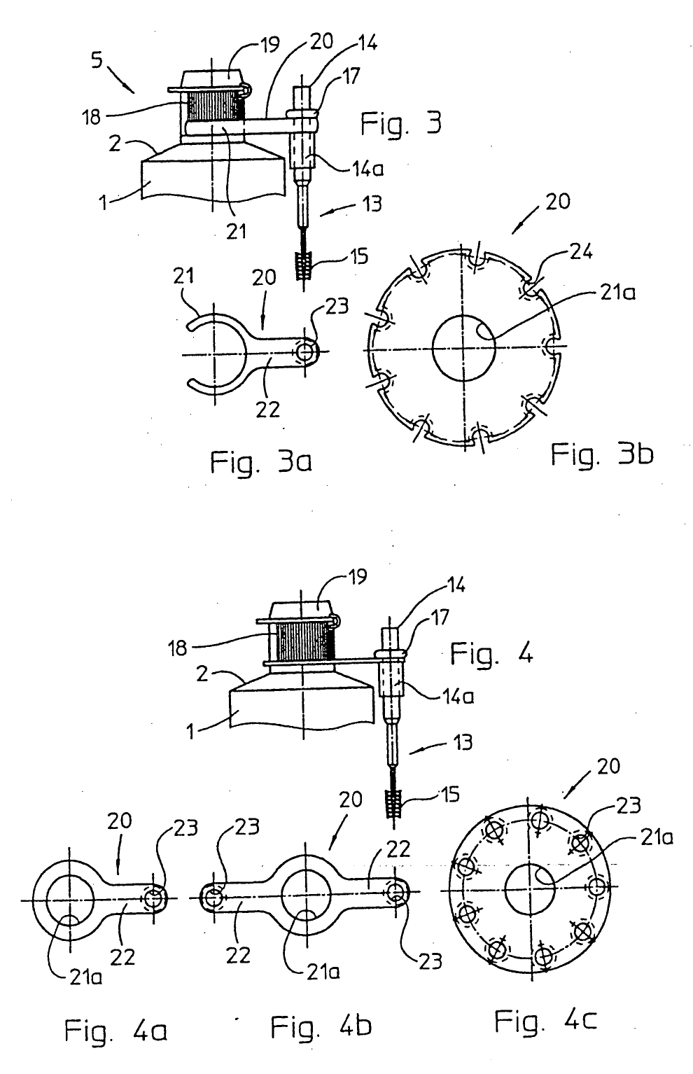

FIG. 3 is a partial side view of a tube body with a third closure and first holding means held thereon,

FIG. 3a is a plan view of the first holding means according to FIG. 3,

FIG. 3b is a plan view of second holding means,

FIG. 4 is a partial side view according to FIG. 3 with third holding means attached on the third closure,

FIG. 4a is a plan view of the third holding means according to FIG. 4,

FIG. 4b is a plan view of fourth holding means,

FIG. 4c is a plan view of fifth holding means,

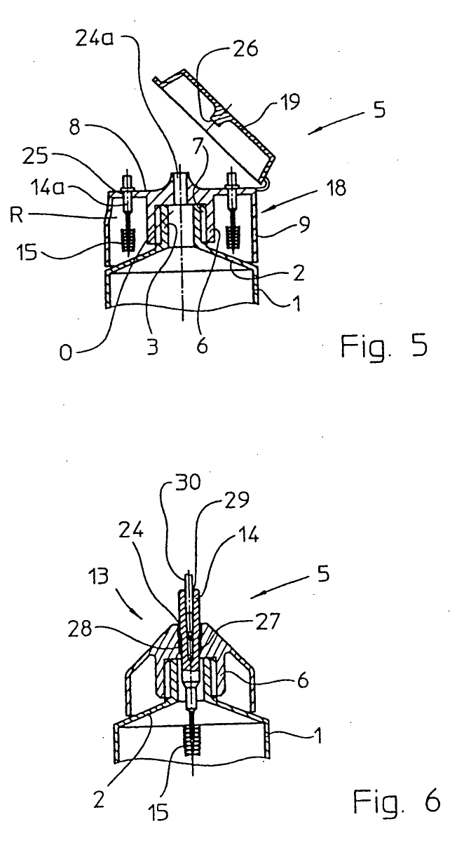

FIG. 5 is a schematic sectional view through a fourth closure, in which the interdental toothbrush projects into a space formed by the closure,

FIG. 6 is a schematic sectional view through a fifth closure,

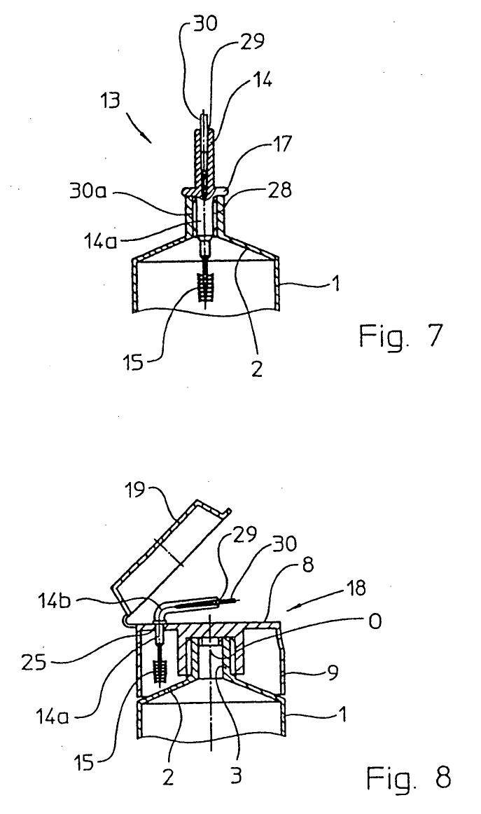

FIG. 7 is a schematic sectional view through a sixth closure,

FIG. 8 is a schematic sectional view through a seventh closure,

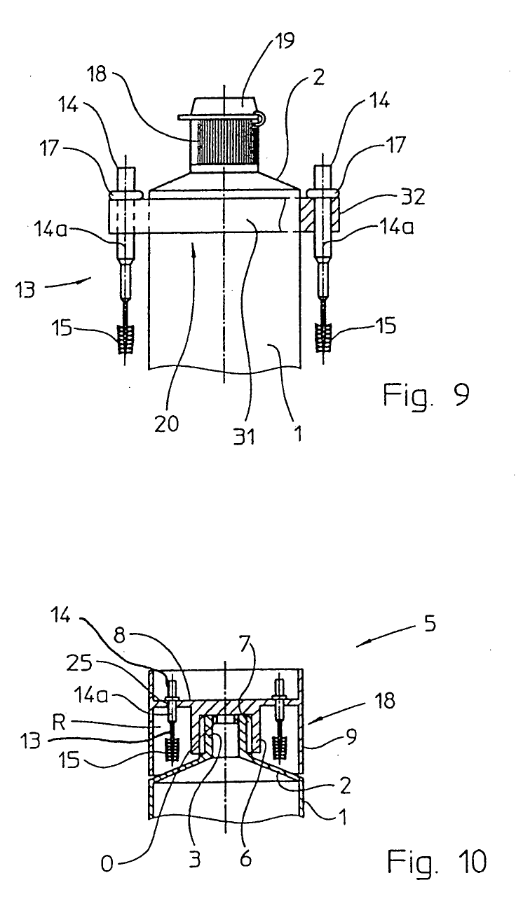

FIG. 9 is a partial side view of the tube body with the third closure, wherein sixth holding means are attached to the tube body,

FIG. 10 is a schematic sectional view through an eighth closure,

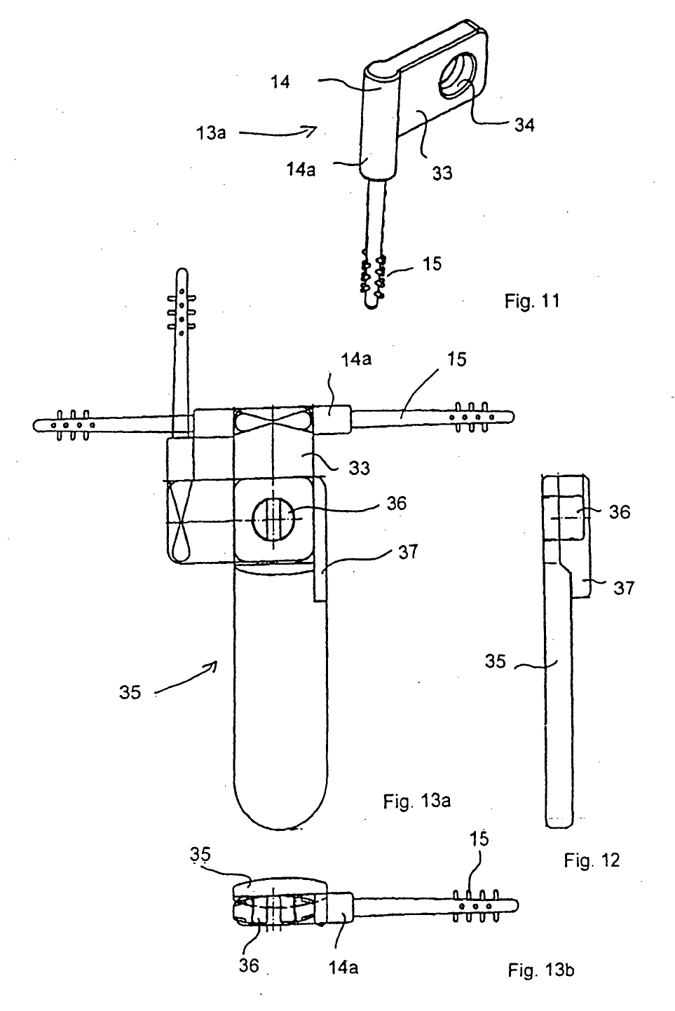

FIG. 11 is a perspective view of another interdental toothbrush,

FIG. 12 is a sectional view of an extension element,

FIG. 13a is a plan view of the extension element according to FIG. 12 with another interdental toothbrush according to FIG. 11 attached thereto and

FIG. 13b is a frontal view according to FIG. 13a,

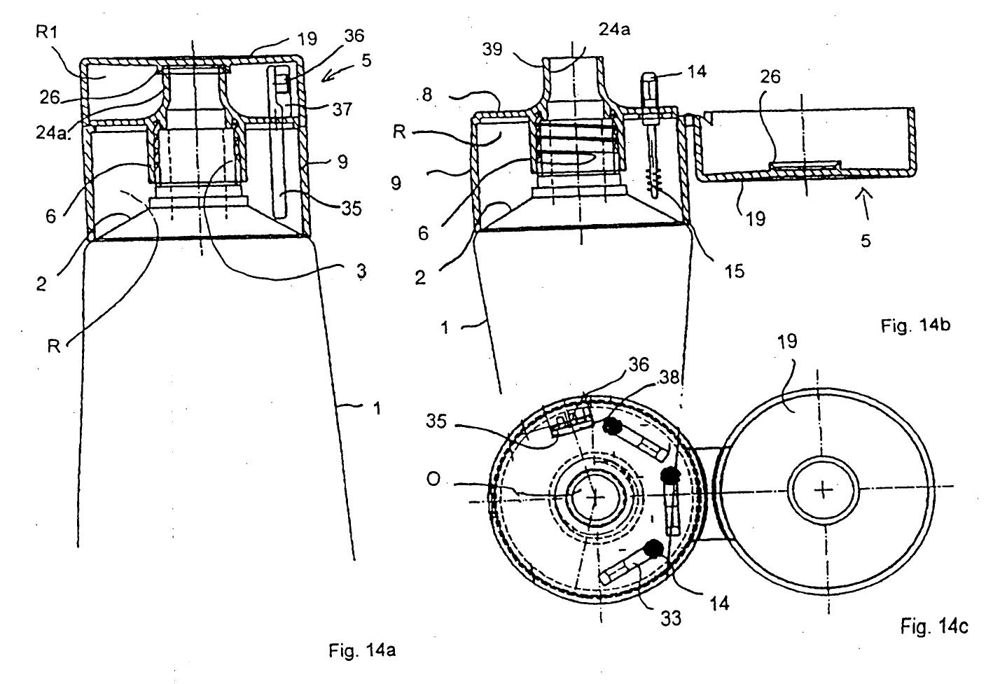

FIG. 14a is a schematic sectional view through a ninth closure,

FIG. 14b is another schematic sectional view according to FIG. 14a with folded back lid, and

FIG. 14c is a plan view of the ninth closure according to FIG. 14b.

In FIGS. 1a and 1b a tube body 1 made e.g. of plastic has a frustoconically designed tube base 2 with a tube nozzle 3 extending therefrom. Provided on the tube nozzle 3 is a first outer thread 4. A tube opening is designated by the symbol O.

A closure 5 preferably made of injection-moulded plastic has a pipe section 6 which is provided with a first inner thread 7 corresponding to the first outer thread 4. A base 8, which is connected to a circular wall 9, here designed cylindrically, extends from the pipe section 6 in a substantially radial direction.

The pipe section 6 has at its one end a first recess 10 which ends at an intermediate base 11 closing the pipe section 6. Opposite the first recess 10 a second recess 12 is provided which likewise terminates on the intermediate base 11. The first 10 and the second recess 12 in each case exhibit the same diameter and approximately the same depth. An interdental toothbrush 13 with gripping part 14 is inserted frictionally engaged into the second recess 12. A holder section 14a to which a brush 15 is attached extends from the gripping part 14.

With the embodiment shown in FIG. 1b the gripping part 14 of the interdental toothbrush 13 is inserted in the first recess 10. In this case the brush 15 projects through the tube opening O into the tube body 1 when the closure 5 is screwed onto the tube nozzle 3.

The abovementioned reference numerals are used for identical components in the following embodiments.

With the second closure shown in FIG. 2 the pipe section 6 is closed with the base 8 extending over the entire diameter of the closure 5. In contrast to the embodiment shown in FIGS. 1a and 1b the circular wall 9 only extends in the direction of the pipe section 6. Several cylindrical third recesses 16 are provided here in the base 8 for frictionally engaged accommodating of the holder section 14a. An outer diameter of the wall 9 is here greater than a diameter of the tube body 1. The third recesses 16 are provided lying radially outwards on the base 8 so that the interdental toothbrushes 13 inserted therein project downwards over the closure 5 and are arranged near the tube body 1. In the illustrated embodiment the gripping parts 14 are in each case delimited by a bead 17 from the holder sections 14a, which limits an insertion depth in the third recesses 16.

In the embodiment shown in FIG. 3 the closure 5 comprises a fastening element 18 which can be screwed onto the tube nozzle 3 and a lid 19 attached movably thereto, which can be latched with the fastening element 18 in the manner of a snap lock. On an outer periphery of the fastening element 18 a holder 20 is held clamped. As is evident in particular in connection with FIG. 3a the holder 20 for clamping fastening comprises fastening means 21 partially encompassing the fastening element 18. In an arm 22 extending from the fastening means 21 a fourth recess 23 is provided for inserting the gripping part 14 of the interdental toothbrush 13.

FIG. 3b shows a second variant of a holder 20. The holder 20 is configured here in the form of a disc which has a preferably central breakthrough 21a as fastening means 21. The diameter of the breakthrough 21a is selected such that the disc can be slipped on the tube nozzle 3 and can be clamped in place by screwing the fastening element 18. Several fifth recesses 24 are provided on the outer periphery of the holder 20 opening outwards for frictionally engaged accommodating of interdental toothbrushes 13.

In the embodiments shown in FIGS. 4, 4a, 4b and 4c a holder 20 is again held clamped on the tube nozzle 3. As is evident from FIG. 4a the holder 20 can also exhibit a breakthrough 21a as fastening means 21, in differing from the embodiment shown in FIG. 3a. In the embodiment shown in FIG. 4b the holder 20 comprises two arms 22, wherein fourth recesses 23 are provided on each of the arms 22 for frictionally engaged accommodating respectively of an interdental toothbrush 13. In the embodiment shown in FIG. 4c and in differing from the embodiment shown in FIG. 3b fourth recesses 23 are provided in the vicinity of the rim of the disc for frictionally engaged accommodating of the interdental toothbrushes 13.

FIG. 5 shows a particularly advantageous variant of the invention. At the same time the closure 5 is again formed from a fastening element 18 and a lid 19 movably attached thereto, e.g. by means of a film hinge. The fastening element 18 has a pipe section 6 provided with the first inner thread 7, which is screwed in the first outer thread 4 of the tube nozzle 3. A base 8 extending from the pipe section 6 has another breakthrough 24a which terminates in the tube opening O. A circular wall 9 extending from the base 8 only in direction of the pipe section 6 has an outer diameter which corresponds approximately to the outer diameter of the tube base 2. A length of the circular wall 9 is selected such that when the fastening element 18 is screwed on the circular wall 9 rests on the tube base 2. In this case, an annularly closed space R is formed by the tube base 2, the base 8 and the pipe section 6. In the base 8 sixth recesses 25 are provided, which can be simple bores. The holder sections 14a of the interdental toothbrushes 13 are plugged into the sixth recesses 25, and in such a way that the brushes 15 project into the space R. On an inside of the lid 19 facing the other breakthrough 24a protruding closure means 26 corresponding to the other breakthrough 24a are formed, with which the other opening 24a can be closed. A circular side wall provided on the lid 19 is designed sufficiently high for the gripping parts 14 projecting out over the base 8 to be covered when the lid 19 is closed.

In the embodiment shown in FIG. 6 the closure 5 has a fastening element 18 which in turn is provided with a pipe section 6, connected via the other breakthrough 24a to the tube opening O. In the vicinity of the other breakthrough 24a the fastening element 18 has a second inner thread 27. A second outer thread 28 corresponding to the second inner thread 27 is provided on the holder section 14a of the interdental toothbrush 13. The interdental toothbrush 13 can be screwed into the other breakthrough 24a to close the other breakthrough 24a. At the same time the brush 15 projects into the tube body 1. In the embodiment shown here the gripping part 14 of the interdental toothbrush 13 has another recess 29, into which a toothpick 30 is inserted, preferably made of injection-moulded plastic.

FIG. 7 shows a particularly easy-to-make embodiment. At the same time a third inner thread 30a is provided on the tube nozzle 3 which corresponds to the second outer thread 28 provided on the holder section 14a of the interdental toothbrush 13. Simply screwing in the interdental toothbrush 13 in the tube nozzle 3 closes off the tube opening. As is evident from FIG. 7 the gripping part 14 here also has another recess 29 into which a toothpick 30 is inserted.

The other embodiment shown in FIG. 8 is configured similarly to the embodiment shown in FIG. 5. However, the base 8 is designed to be continuous here so that a tube opening O is closed by screwing on the fastening element 18. No closure means are provided on the lid 19. An interdental toothbrush 13 here provided with an angled gripping part 14b is in turn inserted into a sixth recess 25 on the base 8. The angled section of the gripping part 14b can also be designed even longer so that it extends almost to the opposite rim of the base 8. The angled gripping part 14b can have another recess 29 for inserting a toothpick 30.

In the embodiment shown in FIG. 9 the holder 20 has a flexible strip 31 as fastening means 21 which encloses the tube body 1 in a force-fitted manner. More pipe sections 32 are attached to the flexible strip 31, into which a gripping part 14 of an interdental toothbrush 13 can be inserted, respectively.

FIG. 10 shows a partial sectional view through an eighth closure. The eighth closure is designed similarly to the fourth closure shown in FIG. 5. Also, sixth recesses 25 are provided in the base 8, into which the holder sections 14a of the interdental toothbrushes 13 are inserted. The brushes 15 of the interdental toothbrushes 13 project into the space R which is encompassed by the tube base 2, the circular wall 9 and the base 8. The tube opening O is closed by the base 8 when screwed on. The circular wall 9 extends from the base 8 to near the tube base 2 and has approximately the same outer diameter as the tube 1. The circular wall 9 extends here from the base 8, but also in the opposite direction by an amount somewhat greater than the height of the gripping parts 14 inserted into the base 8. A circular free upper edge of the circular wall 9 can be closed by a preferably transparent plastic film for originality safeguarding. Such plastic film is to be removed by the user at first use.

FIG. 11 shows a perspective illustration of another interdental toothbrush 13a. The brush 15 is formed from a rotationally symmetrical shaft which defines a longitudinal axis of same. Bristles extend radially from the shaft. Together with the bristles the shaft can be made from injection-moulded plastic. It can also happen that the shaft is made of wire with radially extending bristles attached thereto.

In the other interdental toothbrush 13a shown in FIG. 11 a connecting piece for connecting an extension element extends from the gripping part 14 in a radial direction. The connecting piece here comprises a plate 33. The gripping part 14, the plate 33 and where necessary the brush 15 can be made in one piece from injection-moulded plastic. The plate 33 has a plate breakthrough 34.

FIG. 12 shows a sectional view of an extension element designated by reference numeral 35. The extension element 35 substantially comprises an elongated rectangular plate which has at one end a tapered section, from which a stud 36 extends. A bar 37 limiting the same at the edges also extends from the tapered section.

As evident in particular in relation to FIGS. 13a and b the stud 36 can be designed slotted and have a bead at its free end. As evident from FIGS. 13a and b this enables a latch connection to be made with the plate 33. In the connected state the stud 36 engages in the plate breakthrough 34.

As is further evident from FIGS. 13a and b the interdental toothbrush 13 can be latched with the plate 33 extending therefrom in three different positions on the extension element 35.

FIGS. 14a, b and c show views of a ninth closure which is designed similar to the fourth closure shown in FIG. 5. By way of difference to the fourth closure shown in FIG. 5 the base 8 here additionally has an extension element recess 38, into which the extension element 35 can be inserted, preferably frictionally engaged. As is evident in particular from FIG. 14a the base 8 divides the space R from a further space R1 which in the closed state is limited by the lid 19 and the base 8. The gripping parts 14 and an upper section of the extension element 35 including the stud 36 project into the further space R1. A lower section of the extension element 35 projects into the space R in the inserted state. With the ninth closure shown in FIGS. 14a to c and as a variation from the fourth closure shown in FIG. 5 the closure means 26 are designed in the manner of a lid overlapping a closure nozzle 39 extending from the base 8. The closure nozzle 39 extends from the base 8—similarly as for the fourth closure—at a height which is greater than or equal to another height resulting from the height of the gripping parts 14 relative to the base 8 when the interdental toothbrush 13 is in the inserted state.

The embodiment proposed in FIGS. 11 to 14c is particularly universal. It enables the accommodation of interdental toothbrushes 13, an associated extension element 35 inside a closure for a toothpaste tube. The advantages of using an interdental toothbrush 13 can therefore be made simply, cost-effectively and efficiently, more available to the user and thus a decisive contribution can be made to improved dental hygiene.

### LEGEND

1 tube body
2 tube base
3 tube nozzle
4 first outer thread
5 closure
6 pipe section
7 first inner thread
8 base
9 wall
10 first recess
11 intermediate base
12 second recess
13,13a interdental toothbrush
14 gripping part
14a holder section
14b angle of gripping part
15 brush
16 third recess
17 bead
18 fastening element
19 lid
20 holder
21 fastening means
21a central breakthrough
22 arm
23 fourth recess
24 fifth recess
24a further breakthrough
25 sixth recess
26 closure means
27 second inner thread
28 second outer thread
29 further recess
30 toothpick
30a third inner thread
31 flexible strip
32 further pipe section
33 plate
34 plate breakthrough
35 extension element
36 stud
37 bar
38 extension element recess
39 closure nozzle
O tube opening
R space
R1 further space

1. Toothpaste tube with a closure (5) for holding at least one interdental toothbrush (13), wherein the closure (5) has a pipe section (6) which is connected via a base (8) extending substantially in a radial direction to a circular wall (9), wherein at least one recess (25) for accommodating the interdental toothbrush (13) is provided in the base (8) so that the interdental toothbrush (13) accommodated in the recess (25) in the base (8) projects into a space (R) enclosed by the circular wall (9), the base (8) and a tube base (2).

2. Toothpaste tube as claimed in claim 1, wherein the interdental toothbrush (13) is held by a grip element (14) provided thereon or a holder section (14a) extending therefrom and frictionally engaged in the recess (25).

3. Toothpaste tube as claimed in claim 1, wherein a first inner thread (7) is provided on the closure (5) for engaging in a first outer thread (4) provided on a tube nozzle (3) having a tube opening (O).

4. Toothpaste tube as claimed in claim 1, wherein the base (8) has a breakthrough (24a) connected to the tube opening (O), or the pipe section (6) is closed by the base (8) extending over the entire diameter of the closure (5).

5. Toothpaste tube as claimed in claim 1, wherein a lid (19) is attached to the closure (5), preferably movably.

6. Toothpaste tube as claimed in claim 1, wherein when the lid (19) is in the closed state a further space (R1) limited by the base (8) and the lid (19) is formed, into which the grip elements (14) projecting over the base (8) project.

7. Toothpaste tube as claimed in claim 1, wherein the first inner thread (7) is provided on a tube-side first end of a pipe section (6) exhibiting the breakthrough (24a).

8. Toothpaste tube as claimed in claim 1, wherein the circular wall (9) is designed cylindrical.

9. Toothpaste tube as claimed in claim 1, wherein the circular wall (9) has an outer diameter which corresponds approximately to the outer diameter of the tube base (2).

10. Toothpaste tube as claimed in claim 1, wherein a length of the circular wall (9) is selected such that the circular wall (9) rests on the tube base (2) when the closure is screwed on so that the space (R) is an annular closed space.

11. Toothpaste tube as claimed in claim 1, wherein the lid (19) covers the interdental toothbrush (13) held in the recess (25) in the closed state.

12. Toothpaste tube as claimed in claim 1, wherein the base (8) has another recess for preferably frictionally engaged accommodating of a toothpick (30).

13. Toothpaste tube as claimed in claim 1, wherein in the grip element (14) of the interdental toothbrush (13) a further recess (29) is provided for preferably frictionally engaged accommodating of a toothpick (30).

14. Toothpaste tube as claimed in claim 1, wherein the grip element (14) is designed angled.

15. Toothpaste tube as claimed in claim 1, wherein the interdental toothbrush (13) and/or the toothpick (30) is connected via a predetermined breaking point to the closure (5).

16. Toothpaste tube as claimed in claim 1, wherein the grip element (14) has a connector extending radially with respect to a longitudinal axis of the brush (15), which preferably comprises a plate (33).

17. Toothpaste tube as claimed in claim 16, wherein the plate (33) has a plate breakthrough (34).

18. Toothpaste tube as claimed in claim 1, wherein an extension element (35) is provided which can be connected to the grip element (14) or the connector provided thereon.

19. Toothpaste tube as claimed in claim 18, wherein a stud (36) corresponding to the plate breakthrough (34) for creating a latch connection with the plate (33) is provided at one end of the extension element (35).

20. Toothpaste tube as claimed in claim 18, wherein a bar (37) is provided on the extension element (35) in the vicinity of the stud (36), such that a plate edge rests thereon when the plate (33) is attached to the extension element (35).

21. Toothpaste tube as claimed in claim 18, wherein the base (8) has an extension element recess (38) for preferably frictionally engaged accommodating of the extension element (35).
